(19) United States
(12) Patent Application Publication
(10) Pub. No.: US 2026/0107874 A1
(43) Pub. Date: Apr. 23, 2026

(54) MOVABLE FERTILIZER HOPPER FOR CALIBRATION

(71) Applicant: Stinger Equipment Inc., Buckner, KY (US)

(72) Inventor: David Michael Cook, Jekyll Island, GA (US)

(21) Appl. No.: 19/361,413

(22) Filed: Oct. 17, 2025

Related U.S. Application Data
(60) Provisional application No. 63/709,208, filed on Oct. 18, 2024.

(51) Int. Cl. A01C 17/00

(52) U.S. Cl. CPC A01C 17/001

(57) ABSTRACT

A utility vehicle for dispensing fertilizer including: one or more front steering wheels; one or more rear drive wheels; a frame; a hopper to hold a dry fertilizer material; one or more hopper mounting brackets connecting the hopper to the frame, each of the one or more hopper mounting brackets including a first part and a second; where the second part connects to the first part to extend the first part of the hopper mounting bracket; where the hopper is capable of connection to the first part of the hopper mounting bracket and to the second part of the hopper mounting bracket. When the hopper is connected to the first part of the hopper mounting bracket the hopper is in a use position; while, when the hopper is connected to the second part of the hopper mounting bracket the hopper is in a calibration position.

### BACKGROUND

In the turf industry, professionals use riding fertilizer spreaders to maintain large areas of turf. To calibrate a fertilizer spreader, a user normally measures out an area (e.g., 1000 sq. ft.) and then applies the fertilizer. The user will measure the amount of fertilizer before and after spreading over the 1000 sq. ft. area to determine an amount of fertilizer utilized. This method has multiple limitations. First, this is not very accurate; and second this method necessitates repeated adjustments to the calibration, in particular after using the spreader on turf.

An additional calibration method that may be utilized includes placing a catch tray under the fertilizer being dispensed. However, this method is often difficult as it may require the spreader disc to be removed from the assembly to make room for the tray. Further, since space may be limited for a catch tray, the user may spill and/or be unable to collect substantially all of the material, which is needed for a good calibration.

There is a need for a fertilizer hopper that is designed to be removable or repositionable, thus allowing it to be placed over a standard container (e.g., a bucket) for more accurate and easier calibration.

### SUMMARY OF THE INVENTION

There is a need for a fertilizer hopper that is designed to be removable or repositionable, thus allowing it to be placed over a standard container (e.g., a bucket) for more accurate and easier calibration. This design may also lower the center of gravity of vehicle, which may have the additional benefits of improving performance on hills and making the hopper easier for user to load. The capability to reposition the hopper may also allow for a more compact vehicle design.

In a first aspect, a utility vehicle for dispensing fertilizer includes: one or more front steering wheels; one or more rear drive wheels; a frame; a hopper configured to hold a dry fertilizer material; one or more hopper mounting brackets connecting the hopper to the frame, each of the one or more hopper mounting brackets including a first part and a second; where the second part of the hopper mounting bracket connects to the first part of the hopper mounting bracket to extend the first part of the hopper mounting bracket; where the hopper is capable of connection to the first part of the hopper mounting bracket and to the second part of the hopper mounting bracket; where when the hopper is connected to the first part of the hopper mounting bracket the hopper is in a use position; and where when the hopper is connected to the second part of the hopper mounting bracket the hopper is in a calibration position.

In some implementations, a bottom opening of the hopper is configured to be able to dispense the dry fertilizer material into a receiving container when in the calibration position.

In some implementations, the second part of the hopper mounting bracket connects to a terminal end of the first part of the hopper mounting bracket to extend the first part linearly. In some implementations, the first part and the second part of the hopper mounting bracket are removably connected. In some implementations, the first part and the second part of the hopper mounting bracket are pivotally connected. In some implementations, the first part and the second part of the hopper mounting bracket are slidably connected.

In some implementations, the calibration position extends about 14 inches linearly forward of the use position.

In some implementations, the utility vehicle for dispensing fertilizer further includes a harness extension cable to connect or reconnect the hopper to a control system.

In another aspect, a utility vehicle for dispensing fertilizer includes one or more front steering wheels; one or more rear drive wheels; a frame; a hopper configured to hold a dry fertilizer material; one or more hopper mounting brackets connecting the hopper to the frame, each of the one or more hopper mounting brackets including a first part and a second; where the second part of the hopper mounting bracket connects to connects to a terminal end of the first part of the hopper mounting bracket to extend the first part of the hopper mounting bracket linearly; where the hopper is capable of connection to the first part of the hopper mounting bracket and to the second part of the hopper mounting bracket; where when the hopper is connected to the first part of the hopper mounting bracket the hopper is in a use position; and where when the hopper is connected to the second part of the hopper mounting bracket the hopper is in a calibration position.

### BRIEF DESCRIPTION OF THE DRAWINGS

In order that the embodiments may be better understood, embodiments of movable fertilizer hopper for calibration will now be described by way of examples. These embodiments are not to limit the scope of the claims as other embodiments of a movable fertilizer hopper for calibration will become apparent to one having ordinary skill in the art upon reading the instant description. Non-limiting examples of the present embodiments are shown in figures.

FIG. 1 is perspective view of a utility vehicle (in this instance, a riding applicator) that includes a movable fertilizer hopper consistent with some embodiments described herein.

FIG. 2 is a partial view of the utility vehicle of FIG. 1 with the fertilizer hopper removed to illustrate the hopper mounting brackets in a use position.

FIGS. 3A-B are perspective views of certain components of the utility vehicle. FIG. 3A is a perspective view of a hopper consistent with some embodiments described herein; FIG. 3B is a perspective view of a hopper extension bracket consistent with some embodiments described herein.

FIG. 4 is a partial view of the utility vehicle of FIG. 1 with the fertilizer hopper removed to illustrate the hopper mounting brackets in an extended position.

FIG. 5 is a partial view of the utility vehicle of FIG. 1 with the fertilizer hopper and hopper mounting brackets in an extended position.

### DETAILED DESCRIPTION OF THE INVENTION

It is to be understood that a movable spreader hopper is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

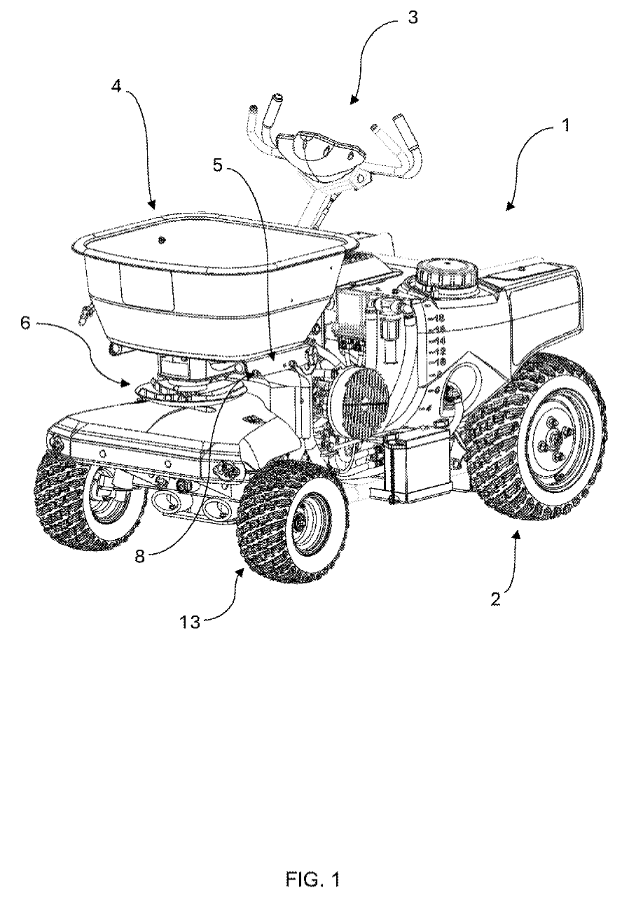

FIG. 1 shows a utility vehicle (in this instance, a riding applicator) that includes a movable fertilizer hopper. The vehicle 1 has front steering wheels 13 and rear drive wheels 2 where an operator can stand between the rear drive wheels and steer the vehicle using the control handle 3 that simultaneously provides steering based on the user input. The vehicle further includes a hopper 4 for holding a dry fertilizer material, one or more hopper mounting brackets 5 for attaching the hopper 4 to the vehicle 1. Fertilizer may be dispensed through a bottom opening 12 of the hopper 4 on a spreader disc 6 for dispersing the dry fertilizer material in a wide, even pattern.

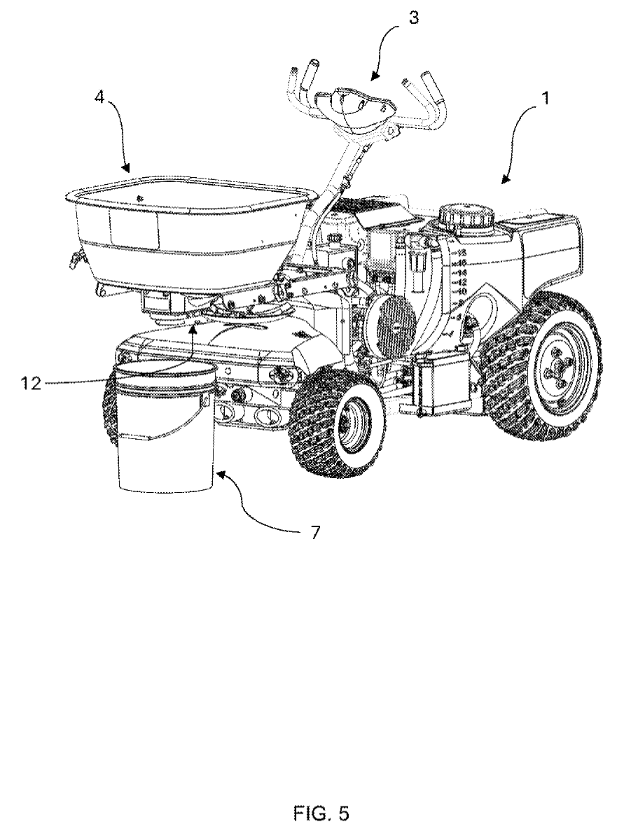

In FIG. 1 the hopper mounting brackets 5 currently have the hopper 4 placed in the use position, meaning the hopper is disposed over the spreader disc 6 and is in a position to dispense the dry fertilizer material. However, this position of the hopper 4 is not particularly conducive to the process of calibrating the vehicle 1. To make the process of catching fertilizer and measuring the weight for the purpose of vehicle calibration, a system where the hopper 4 (and accordingly the bottom opening 12 of the hopper 4) can be relocated from the original position (see FIG. 1) where it is normally used to a calibration position (see FIG. 5) is described herein. In the example discussed and illustrated herein, the hopper is relocated forward linearly approximately 14 inches to allow a receiving container 7 to be placed below the hopper 4 to catch the dry fertilizer material. However, this is not intended to be limiting, as a person of skill in the art would recognize that the hopper 4 may be relocated forward any distance or be relocated in any other direction practical to allow for placement of the receiving container 7.

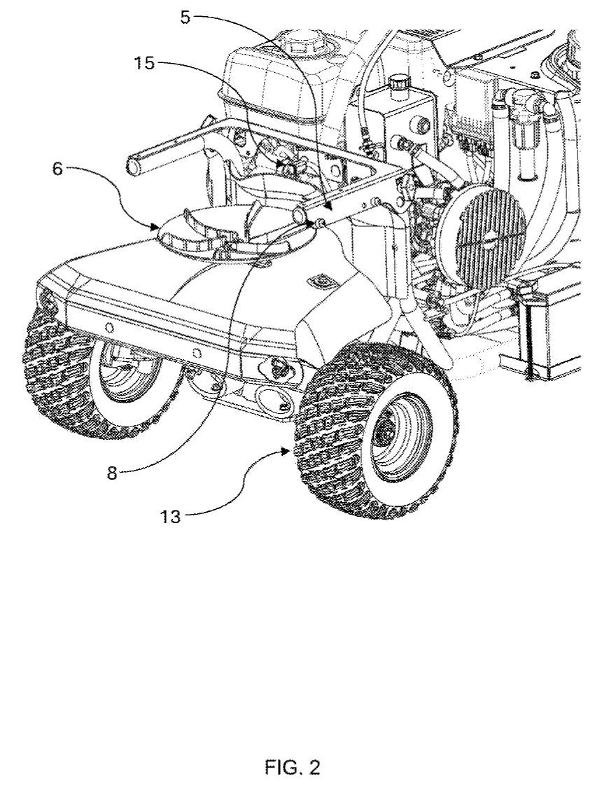

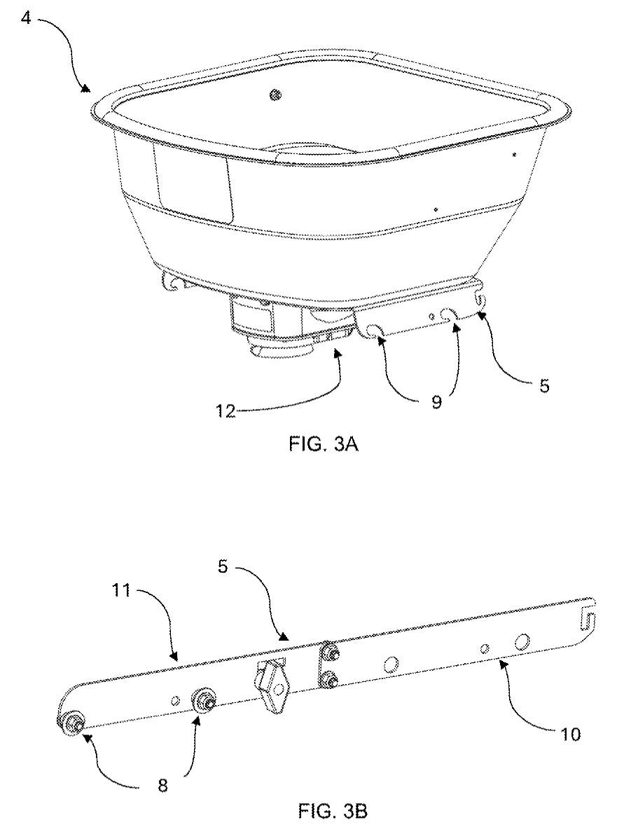

FIG. 2 illustrates a portion of the utility vehicle 1 with the fertilizer hopper removed to illustrate the hopper mounting brackets 5 in a use position. As illustrated, the hopper mounting brackets 5 each include one or more attachment points 8 for receiving the hopper 4. As best illustrated in FIG. 3A, the hopper 4 may additionally include one or more corresponding attachment points 9 for coupling with the attachment points 8 on the hopper mounting brackets 5. In the illustrated embodiment, and as also illustrated in FIG. 3B, the one or more attachment points 8 (for receiving the hopper 4) on the hopper mounting brackets 5 include at least one or more of bolts, nuts, washers, or a combination thereof that are received by a corresponding opening (e.g., corresponding attachment point 9) on the hopper 4. However, this is not intended to be limiting, as the attachment points 8, 9 of the hopper 4 and the mounting hopper brackets 5 may vary. A person of skill in the art will recognize that there are numerous ways for a hopper 4 to be coupled to a hopper mounting bracket 5. Other, non-limiting, mounting methods may include screws, other connectors, or the like. When in the use position, as illustrated in FIGS. 1 and 2, mounting brackets 5 position the hopper 4 directly over the spreader disc 6 to allow for the dry fertilizer material to be dispensed.

Referring again now to FIGS. 3A-B, an example hopper (FIG. 3A) and hopper mounting bracket 5 (FIG. 3B) are illustrated. The illustrated hopper mounting bracket is in an extended or calibration position, such that both a first part 10 and a second part 11 are visible. In some implementations, the hopper mounting bracket 5 may be two separate, disconnected pieces – the first part 10 and the second part 11. In such implementations, the user would attach the second part 11 to the vehicle 1 or to the first part 10 to extend the length of the hopper mounting bracket 5, thus moving the positioning of the attachment points 8 and the positioning of the hopper 4. In other implementations, the first part 10 and the second part 11 of the hopper mounting bracket 5 may be rotatably connected; for example, such that the second part 11 may rotate toward the first part 10 and nest therein for storage. In still other implementations, the first part 10 and the second part 11 of the hopper mounting bracket 5 may be slidably connected; for example, such that the second part 11 may slide toward the first part 10 and nest therein for storage. The process of moving the hopper 4 to facilitate calibration may utilize the extension of the hopper mounting bracket 5 utilizing any of the previously described configurations or any others known in the art.

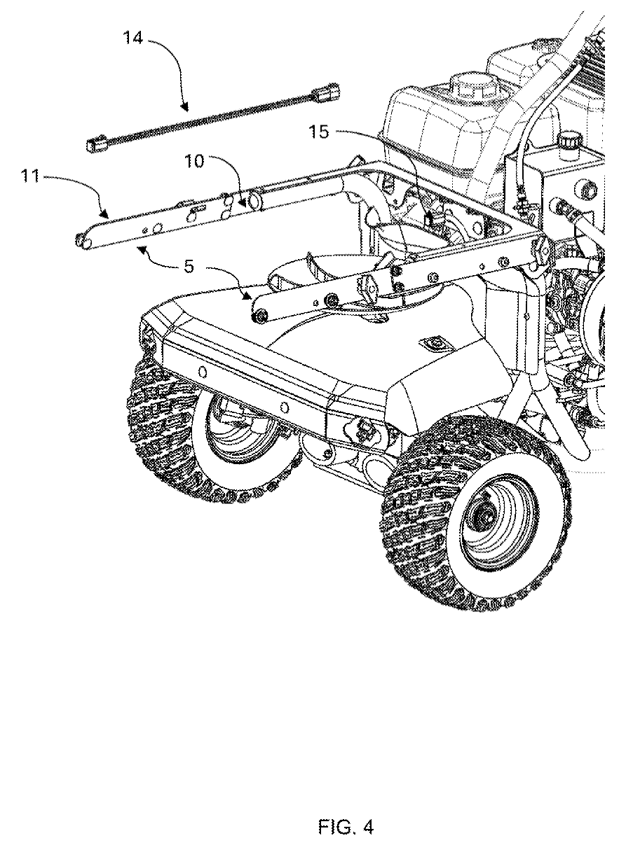

Turning now to FIG. 4, the hopper mounting brackets extend the mounting surface to relocate the hopper 4 (and accordingly, the bottom opening 12 of the hopper 4) approximately 14 inches forward of the dispensing position for the purpose of catching fertilizer for calibrating; however, this distance is not intended to be limiting. In some implementations, such as illustrated herein, the utility vehicle may be electronically controlled. In some such implementations, a hopper connector 15 receives a harness cable to transmit data from the hopper 4 to a vehicle control system (not illustrated). In some instances, a harness extension cable 14 may be needed to connect or reconnect the hopper controls to the control system during the calibration process. In some instances, the vehicle 1 may include a cable long enough to work when the hopper 4 is in an extended position. In other instances, a separate, longer harness extension cable 14 may need to be used when the hopper 4 is in the extended position for calibration. In some instances, the utility vehicle 1 may have mechanical controls, and thus may not require a harness connection to the hopper.

FIG. 5 illustrates the vehicle 1 with the hopper 4 (and accordingly the bottom opening 12 of the hopper 4) relocated from the original position (see FIG. 1) where it is normally used to a calibration position with a receiving container 7 placed under the bottom opening 12 of the hopper 4. In the illustrated embodiment, the receiving container 7 is a standard five (5) gallon bucket, but any suitable container may be used for the collection of the dispensed dry material. As illustrated in FIG. 5, the hopper 4 includes one or more corresponding attachment points 9 to couple with the attachment points 8 on second part 11 of the hopper mounting brackets 5. This attachment extends the position of the hopper 4 into a calibration position.

The repositioning of the hopper 4 on the hopper mounting bracket 5 allows the hopper 4 and bottom opening 12 of the same to extend outward linearly from the vehicle 1. Repositioning the hopper allows for the hopper 4 to be positioned lower on the vehicle as compared to traditional designs. For example, the hopper 4 may be located approximately 6 to 12 inches lower than a traditional design. Accordingly, the center of gravity of the vehicle is lowered, in particular when the hopper is filled with dry fertilizer material. A lowered center of gravity increases performance on hills. For example, with the hopper lower the spread pattern is improved; in contrast, with a traditional design there is a larger gap between the bottom of the fertilizer hopper and the spreader disc to make room for a catch tray which can degrade spreading performance on hills. More specifically, when a traditionally designed vehicle (e.g., with a larger gap) traverses a hill with a larger gap the dry material may fall to the side without landing on the spreader disc as intended. This may result in an uneven spread pattern and/or wasted dry fertilizer material. Furthermore, a lower hopper may also make it easier for a user to load the dry material into the hopper. Additionally, the ability to reposition the hopper 4 for calibration may allow for an overall more compact vehicle design. Traditional designs may require extra room below the hopper and spreader disc to catch material for calibration; this space is not necessary with the design presented herein.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

1. A utility vehicle for dispensing fertilizer comprising:
one or more front steering wheels;
one or more rear drive wheels;
a frame;
a hopper configured to hold a dry fertilizer material;
one or more hopper mounting brackets connecting the hopper to the frame, each of the one or more hopper mounting brackets including a first part and a second;
wherein the second part of the hopper mounting bracket connects to the first part of the hopper mounting bracket to extend the first part of the hopper mounting bracket;
wherein the hopper is capable of connection to the first part of the hopper mounting bracket and to the second part of the hopper mounting bracket;
wherein when the hopper is connected to the first part of the hopper mounting bracket the hopper is in a use position; and
wherein when the hopper is connected to the second part of the hopper mounting bracket the hopper is in a calibration position.

2. The utility vehicle for dispensing fertilizer of claim 1, wherein when in the calibration position a bottom opening of the hopper is configured to be able to dispense the dry fertilizer material into a receiving container.

3. The utility vehicle for dispensing fertilizer of claim 1, wherein the second part of the hopper mounting bracket connects to a terminal end of the first part of the hopper mounting bracket to extend the first part linearly.

4. The utility vehicle for dispensing fertilizer of claim 1, wherein the first part and the second part of the hopper mounting bracket are removably connected.

5. The utility vehicle for dispensing fertilizer of claim 1, wherein the first part and the second part of the hopper mounting bracket are pivotally connected.

6. The utility vehicle for dispensing fertilizer of claim 1, wherein the first part and the second part of the hopper mounting bracket are slidably connected.

7. The utility vehicle for dispensing fertilizer of claim 1, wherein the calibration position extends about 14 inches linearly forward of the use position.

8. The utility vehicle for dispensing fertilizer of claim 1, further including a harness extension cable to connect or reconnect the hopper to a control system.

9. A utility vehicle for dispensing fertilizer comprising:
one or more front steering wheels;
one or more rear drive wheels;
a frame;
a hopper configured to hold a dry fertilizer material;
one or more hopper mounting brackets connecting the hopper to the frame, each of the one or more hopper mounting brackets including a first part and a second;
wherein the second part of the hopper mounting bracket connects to connects to a terminal end of the first part of the hopper mounting bracket to extend the first part of the hopper mounting bracket linearly;
wherein the hopper is capable of connection to the first part of the hopper mounting bracket and to the second part of the hopper mounting bracket;
wherein when the hopper is connected to the first part of the hopper mounting bracket the hopper is in a use position; and
wherein when the hopper is connected to the second part of the hopper mounting bracket the hopper is in a calibration position.

10. The utility vehicle for dispensing fertilizer of claim 9, wherein when in the calibration position a bottom opening of the hopper is configured to be able to dispense the dry fertilizer material into a receiving container.

11. The utility vehicle for dispensing fertilizer of claim 9, wherein the first part and the second part of the hopper mounting bracket are removably connected.

12. The utility vehicle for dispensing fertilizer of claim 9, wherein the first part and the second part of the hopper mounting bracket are pivotally connected.

13. The utility vehicle for dispensing fertilizer of claim 9, wherein the first part and the second part of the hopper mounting bracket are slidably connected.

14. The utility vehicle for dispensing fertilizer of claim 9, wherein the calibration position extends about 14 inches linearly forward of the use position.
